(19) United States
(12) Patent Application Publication
(10) Pub. No.: US 2005/0094330 A1
(43) Pub. Date: May 5, 2005

(54) Intermediate bus power architecture

(76) Inventors: Robert A. Guenther, Pepperell, MA (US); Raoji A. Patel, Framingham, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/701,881

(22) Filed: Nov. 5, 2003

(51) Int. Cl. H02H 7/00

(52) U.S. Cl. 361/18

(57) ABSTRACT

Systems, methodologies, components, and other embodiments associated with converting power and bus architectures are described. One exemplary system embodiment comprises a first set of power converters configured to convert a received input power level to one or more power levels, and a second set of power converters. An interleaved intermediate bus is configured to supply independent and redundant input to the second set of power converters from the one or more output power levels of the first set of power converters.

### BACKGROUND

Intermediate bus (IB) power architectures are one solution for applications that require low cost and flexibility in power system design. As illustrated in FIG. 1, a prior art power system design is shown that distributes an input voltage of +48V to a number of desired system voltages such as +3.3V, +1.5V, and +5V. The design uses an intermediate bus power architecture configured with a common intermediate bus 100 that supplies power from a first set of power converters (e.g., isolated converters 105) to a second set of power converters (e.g., non-isolated converters 110). The non-isolated converters 110 operate from the common voltage on the intermediate bus 100. However, extending this architecture to an N+1 application required additional components to isolate the non-isolated converters 110 from power component failures that can disturb the common intermediate bus voltage.

For example, an input fault within one of the non-isolated converters 110 will cause a disturbance on the intermediate bus 100 and thereby affect the operation of the remaining good non-isolated converters 110. This situation was addressed by adding fault protection components to the circuit. For example, the intermediate bus 100 includes a fuse 115, an isolation diode 120, and local storage capacitance 125 on the input of each non-isolated converter 110. Upon an input fault on a failing non-isolated converter 110, the fuse 115 would be cleared to remove the failing non-isolated converter from the circuit. The isolation diode 120 and local storage capacitance 125 provide isolated stored energy to the remaining good non-isolated converters that allow them to operate through the disturbance created on the intermediate bus 100 as the fuse is cleared. Additionally, isolation diodes 130 are positioned on the outputs of all the isolated power converters 105 to prevent faults within these converters from affecting the intermediate bus 100. The use of isolation diodes 120 and 130 can increase power system losses and can decrease power system efficiency. In general, additional circuit components can add cost, increase power losses, and can reduce hardware reliability.

The circuit may also include any number of other components such as a hot swap manager 135 and a filter 140. The hot swap manager 135 is a component that provides control of in-rush current that may occur when plugging in components. The filter 140 may be an EMI-type filter to reduce or prevent high frequency noise from traveling back through the circuit. These components are not important to the discussions herein and will not be further described.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a prior art example of power system design and an intermediate bus architecture.

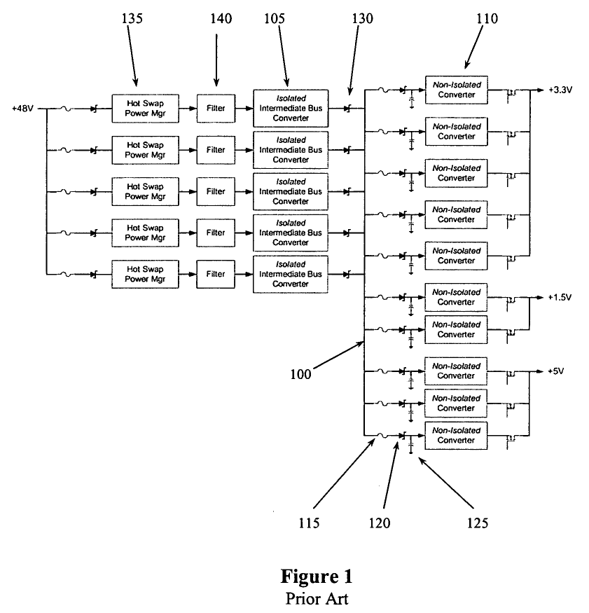

FIG. 2 illustrates one example of a power conversion system including an intermediate bus architecture.

FIG. 3 illustrates another example circuit configuration of an intermediate bus architecture included in an example power conversion system.

FIG. 4 illustrates another example of an intermediate bus architecture.

FIG. 5 illustrates an example methodology of converting an input power level.

FIG. 6 illustrates an example methodology associated with forming a power conversion circuit.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection may include a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, other software, a logic device, a chip, a circuit, or other entity. Logical and/or physical communication channels can be used to create an operable connection.

“Signal”, as used herein, includes but is not limited to one or more electrical or optical signals, analog or digital, one or more computer or processor instructions, messages, a bit or bit stream, or other means that can be received, transmitted, and/or detected.

It has proven convenient at times, principally for reasons of common usage, to refer to signals as voltages, currents, power levels, bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, providing, transmitting, supplying, computing, calculating, determining, displaying, or the like, refer to actions and processes of a computer system, logic, processor, or similar electronic device that manipulates and/or transforms signals represented as physical (electronic) quantities.

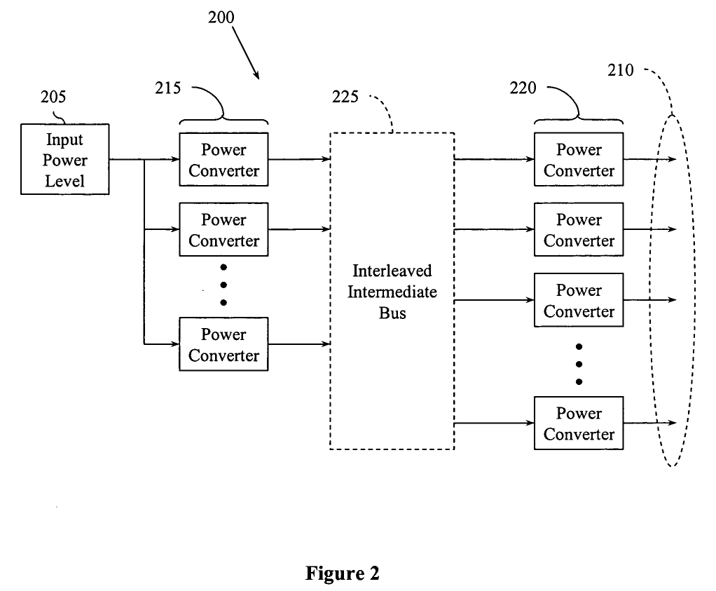

Illustrated in FIG. 2 is one example of a power conversion circuit 200 configured to convert an input power level 205, such as a voltage level from a power source, to one or more desired output power levels 210. One application of the power conversion circuit 200 can be to take a +48 volt input power level 205 and convert or distribute the power level to multiple different output power levels 210. The output power levels 210 can include multiple voltage levels that can be used as input to electronic components requiring system loads less than the input power level 205. Examples of electronic components can include application specific integrated circuits (ASIC), other types of chips, circuits, or other logic devices.

It will be appreciated that the power conversion circuit 200 can be used in many electronic environments such as on a printed circuit board of a computer or other electronic device where power levels are converted/distributed to other components. An electronic device may also include any number of power conversion circuits 200 that may have different combinations and configurations of components based on the desired types of power conversion and power distribution needed.

With further reference to FIG. 2, the power conversion circuit 200 can include a first set of power converters 215 and a second set of power converters 220 that are connected by an interleaved intermediate bus 225. The first set of power converters 215 are configured to convert the input power level 205 to a desired intermediate level. For example, the power converters 215 can be +48 volt to +12 volt converters. Of course, other types of converters can be used that have different input/output ranges as well as other combinations of converters. The output from the power converters 215 are supplied to the input of the second set of power converters 220 through operable connections with the interleaved intermediate bus 225. The second set of power converters 220 further convert the power level to a desired output level 210.

As one example, the interleaved intermediate bus 225 can be configured with multiple independent intermediate buses to supply input to individual power converters 220. If a fault occurs on any one of the independent intermediate buses, the fault may affect the particular power converter 220 that it is connected to but would not affect the other, separate independent buses and thus, not affect the other power converters 220. Furthermore, to support an N+1 application, the conversion circuit 200 can be configured to have multiple power converters 220 operating in parallel to support a particular system load and provide N+1 redundancy.

For example, a group of the power converters 220 can have their outputs combined to generate one system output level 210 where the group includes at least one redundant power converter. Thus, if one of the power converters 220 in the group would go down, the group would still have enough power to generate the system output level 210 associated with the group. Thus generally speaking, each output 210 of the circuit has connected to it, an extra power converter 220 and an extra independent intermediate bus from one of the power converters 215 so that any of the independent intermediate buses associated with a group power converters 220 can fail and the output 210 can still be generated.

As will be described with reference to the following examples, the interleaved intermediate bus 225 can be configured to provide voltages on multiple intermediate buses from the first set of power converters 215 to the second set of power converters 220 such that a loss or disturbance on any one of the multiple intermediate buses will not affect the system load on the other intermediate buses. Furthermore, the interleaved intermediate bus 225 can be configured to supply redundant input to the second set of power converters 220 from one or more output power levels from the first set of power converters 215. With the interleaved intermediate bus 225, the bus can be configured without fault protection components and still provide a desired level of system reliability.

It will be appreciated that the first set of power converters 215 can include isolated power converters. The second set of power converters 220 can include non-isolated converters. Of course, other types of power converters or transformers can be used and can be interchanged and/or combined in different combinations and configurations.

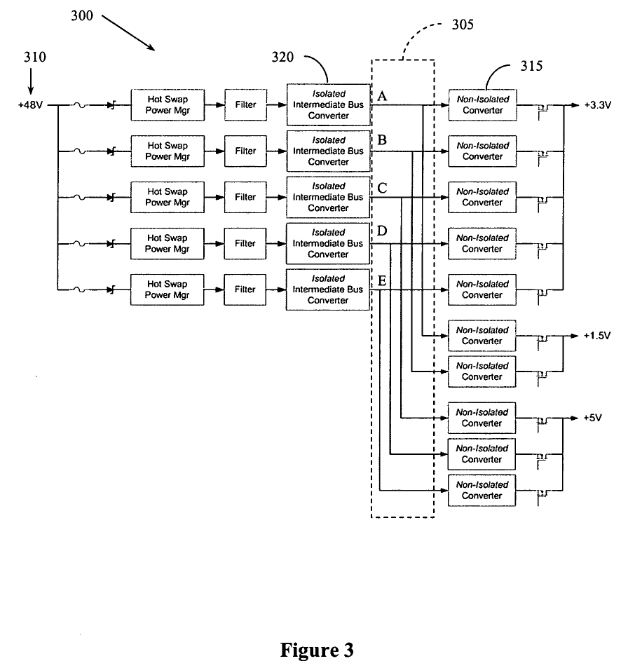

Illustrated in FIG. 3 is another example of a power conversion system 300 that includes an example of an intermediate power bus architecture 305. In the illustrated example, the power conversion circuit 300 is configured to convert a +48 volt input voltage level 310 into three output voltages (e.g. system loads) shown as +3.3 volts, +1.5 volts, and +5 volts. It will be appreciated that other input levels can be used as well as other types and combinations of converters to generate one or more desired output levels. It will be further appreciated that each output voltage can be generated by using one or more power converters, such as non-isolated converters 315, that are selectively combined in parallel.

For example, the +3.3 volt output level can be generated by combining five (5) non-isolated converters 315. Additionally, each output voltage (e.g. +3.3 volts, +1.5 volts, and +5 volts) can be produced by having a redundant (N+1) non-isolated converter within its group. Thus, if one of the non-isolated converters 315 in the group associated with the +3.3V output would fail, the other four (4) non-isolated converters would generated enough power to provided the +3.3V output.

The circuit 300 can include one or more power converters, such as isolated intermediate bus converters 320, that can be configured to distribute the input voltage level of +48 volts to an intermediate voltage level. The intermediate voltage level is then supplied to the non-isolated converters 315 across the intermediate bus architecture 305. In one example, each isolated converter 320 can be a power transformer that converts a +48 volt input level to a +12 volt output level. One example is a BusQor BQ50120QTA20 bus converter module manufactured by SynQor. Of course, other types and numbers of converters can be used, as well as converters having different input/output ranges.

The non-isolated converters 315 can be, for example, a DC/DC converter such as a SIL30C series non-isolated converter manufactured by Artesyn Technologies. Each of the non-isolated converters 315 can be configured to accept a range of input voltages and provide a range of output voltages. For example, the non-isolated converter 315 can include one or more trim pins that allow the output to be adjustable to a selected voltage level, for example between a 0.9 volt to 5 volt output voltage range. In this manner, a selected number of non-isolated converters 315 can be combined in parallel to produce a desired output voltage level. For example, the +5 volt output level shown in FIG. 3 can be produced by using three (3) non-isolated converters 315.

With further reference to FIG. 3, the intermediate bus architecture 305 can be configured to be interleaved to supply independent and redundant input to the set of non-isolated converters 315 from the output power levels from the set of isolated converters 320. For example, the bus architecture 305 can include multiple intermediate buses (e.g. buses A-E) where each bus carries an output signal that is separate and independent from the other bus signals, making each bus A-E isolated from each other. Each intermediate bus A-E is configured to provide input power to no more than one non-isolated converter 315 per output voltage (e.g., 3.3 volts, 1.5 volts, 5 volts). In other words, any given intermediate bus A-E supplies only one input per group of non-isolated converters.

Thus in the example configuration, the +3.3 volt output is generated from a first group of five (5) non-isolated converters 315 operating in parallel to support the load and provide N+1 redundancy. As such, five intermediate buses A-E are configured to provide an independent input voltage to each of the five non-isolated converters 315. The other non-isolated converters are combined as two other groups that generate the other system voltages (e.g., +1.5 volts and +5 volts). Each group of non-isolated converters are configured to receive selective input from the five intermediate buses A-E in a distributed manner.

In a particular example from FIG. 3, the intermediate bus “A” is configured to provide input power (e.g. voltage) to one non-isolated converter 315 associated with the output voltage +3.3 volts and does not provide input to any other non-isolated converter associated with the same output voltage. This can be regarded as a one-to-one relationship where within a group of non-isolated converters 315, no two converters share an intermediate bus or receive input from a common intermediate bus. Rather, the intermediate bus “A” can be distributed to a different non-isolated converter in another group, such as a converter associated with the +1.5 volt output. Likewise, the non-isolated converters 315 that are grouped and associated with a particular output voltage are configured to receive input power from different intermediate buses A-E from the isolated converters 320 such that a selected number of the isolated converters 320 provide an independent input voltage to one non-isolated converter 315 per output voltage. Thus, for each group of non-isolated converters 315 per output voltage, the group includes a redundant bus from the independent intermediate buses A-E.

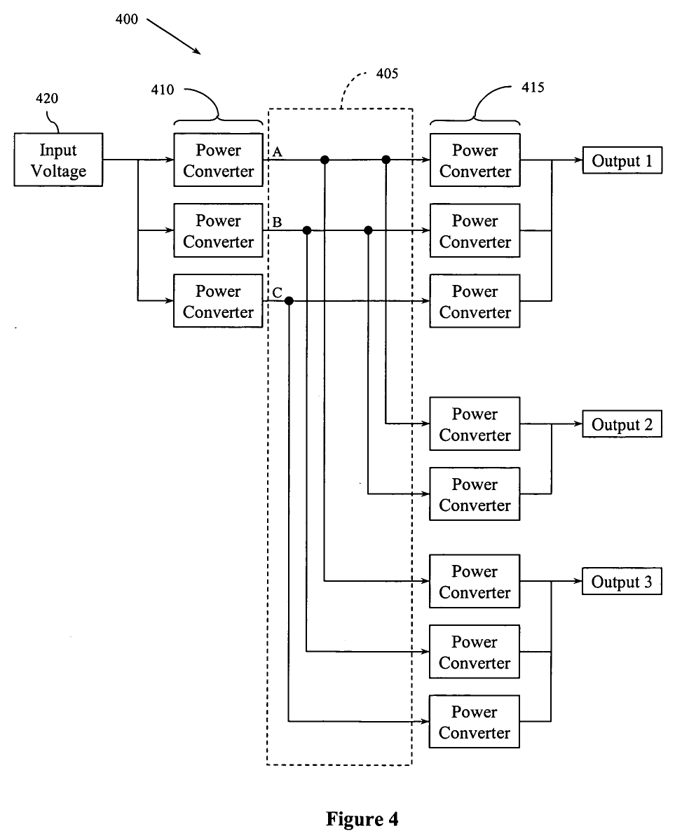

The interleaved intermediate bus 305 can be configured, in one example, where each independent bus A-E is split to provide an input to two (2) non-isolated converters 315. It will be appreciated that the intermediate bus 305 can be configured where the independent buses A-E are configured to provide input to one or more non-isolated converters 315. Another example of an interleaved bus configuration is shown in FIG. 4.

Illustrated in FIG. 4 is another example of a power conversion system 400 that includes an interleaved intermediate bus 405. Similar to the previous examples, the intermediate bus 405 has an architecture configured to connect one set of power converters 410 to a second set of power converters 415. Overall, the power conversion system 400 is configured to convert an input voltage 420 into one or more output voltages such as output 1, output 2, and output 3. Output from each of the power converters 410 are provided on an independent intermediate bus labeled A, B, and C, respectively. The output from each independent bus A-C can then be supplied as an independent input to separate power converters 415 that are combined to form the output 1. In other words, any one of the independent buses A, B, or C is not connected to more than one power converter 415 in the group that forms output 1.

The interleaved intermediate bus 405 is interleaved by configuring the independent buses A-C to provide separate input to a group of power converters 415 per output voltage (e.g. output 1). The independent buses A-C are also split to provide selective input to other groups of power converters 415 (e.g. output 2 and/or 3). For example, the bus “A” provides input to two other power converters, one forming the group associated with output 2 and one converter associated with the group forming output 3. The independent buses B and C are also similarly interleaved to provide input power/voltage to one or more power converters 415.

As described previously, each of the outputs 1-3 are formed with a redundant power converter 415 (e.g. N+1) that receives power from an independent bus A-C, thus making that bus a redundant bus. This configuration allows one power converter 415 per output group to fail or one of the independent buses A-C to fail without affecting the outputs 1, 2, or 3.

In this manner, fault protection components may be eliminated from the interleaved intermediate bus architecture 405 since a power component failure will only affect one power path (e.g., voltage on bus A, B, or C) associated with a particular group of power converters 415 that are combined to form a desired output. The remaining power paths will be undisturbed and can support the system load due to the N+1 redundancy in the number of power converters 415. It will be appreciated that in the design of the power conversion system 400 or other circuits described herein, any number of power converters can be used and combined in any desired manner to convert an input voltage level to a desired output voltage level.

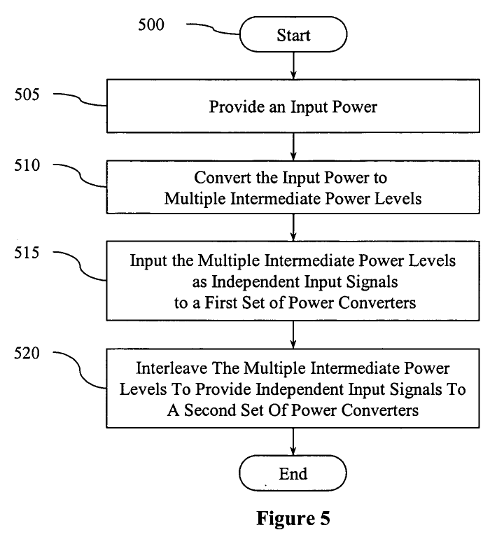

With reference to FIG. 5, an example methodology 500 associated with converting a power level to one or more output power levels is shown. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, logic device, methodology, or style (e.g., procedural, object-oriented). Rather, a flow diagram illustrates functional information one skilled in the art may employ to develop logic to perform the illustrated processing. It will be further appreciated that electronic and software applications may involve dynamic and flexible processes so that the illustrated blocks can be performed in other sequences that are different from those shown and/or that blocks may be combined or separated into multiple components.

With reference to FIG. 5, initially, an input power is provided (Block 505) such as a voltage level. The input power is then converted to multiple intermediate power levels that are carried on independent buses (Block 510). In one example, the intermediate power levels can include multiple outputs of any equal value or in another example, can include different output values. The multiple intermediate power levels are then inputted as independent signals to a first set of power converters (Block 515). In this respect, the first set of power converters could include a group of non-isolated converters that are combined together to form a single output voltage. As an example, the first set of power converters could correspond to the five (5) non-isolated converters 315 grouped and associated to the +3.3V output shown in FIG. 3. An independent input signal is inputted to each non-isolated converter 315 in that group which includes a redundant input signal for the redundant non-isolated converter in that group.

The multiple intermediate power levels are also interleaved to provide independent input signals to a second set of power converters including a redundant input signal (Block 520). In this respect, the second set of power converters could include another group of non-isolated converters that are combined to form a separate output voltage such as the +1.5 volt output shown in FIG. 3. Thus, the multiple intermediate power levels are supplied as input power to no more than one converter per output voltage. Additionally, each set or group of power converters includes a redundant converter that receives input from an independent bus that is redundant for that group.

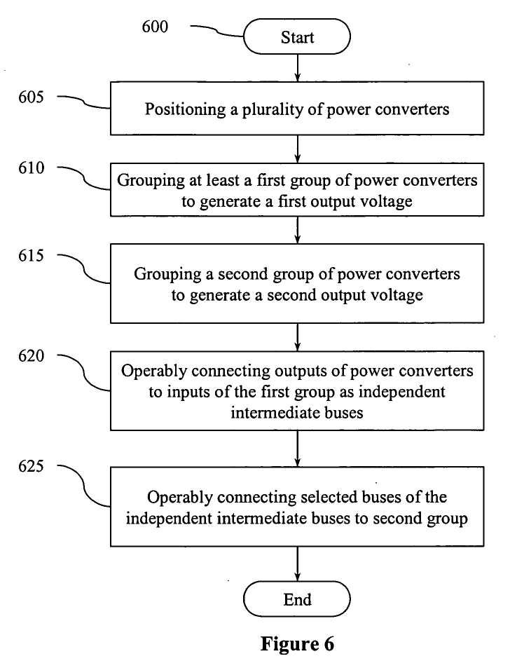

Illustrated in FIG. 6 is an example methodology 600 associated with forming a power conversion circuit. The methodology 600 may be applied, for example, when fabricating or manufacturing a circuit, a printed circuit board, a chip, and/or other logic device and may be applied to form any of the example interleaved intermediate buses or similar bus architectures described above.

With reference to FIG. 6, a plurality of power converters can be positioned to convert an input voltage to a plurality of intermediate voltages (block 605). This may include positioning the power converters like the set of isolated converters shown in FIG. 3. At least a first group of power converters are grouped to generate a first output voltage including at least one redundant converter (block 610) and grouping a second group of power converters to generate a second output voltage including at least one redundant power converter (block 615). Outputs of the plurality of power converters are operably connected to inputs of the first group of power converters as independent intermediate buses (block 620). Selected buses of the independent intermediate buses are operably connecting to separate inputs of the second group of power converters (block 625).

As described in previous examples, using independent buses allow the buses to be designed without including fault protection components. The operably connecting steps form an interleaved power bus that includes the independent intermediate buses. For example, in each group of power converters, the inputs can be connected to each of the independent intermediate buses as a one-to-one relationship. In other words, only one input from each intermediate bus is connected to a group of power converters per each output voltage. Reference to FIGS. 3 and 4 also give examples of these types of connections, interleaved bus architectures, and relationships of components that can be produced with the methodology 600 or similar methodology.

It will be appreciated that the power conversion systems and/or circuits as described herein may be embodied in a variety of desired applications. For example, the power conversion system can be embedded into a computer, a server, a central processing unit (CPU) board, an input/output chassis, and/or in any desired electronic component or product, like an image forming device, where an input power level is desired to be converted to one or more output levels. The input power level can be converted or distributed to different output power levels that become input to components such as ASICS, chips, and/or other logic devices. It will be appreciated that any of the described power converters can be implemented by using isolated converters, non-isolated converters, AC or DC power transformers, other types of converter circuits or logic, and can be interchanged with other types of converters as desired for converting an input power level to a different power level. Furthermore, any of the described bus architectures can be used for redundantly connecting a first set of power converters to a second set of power converters and to supply an intermediate power level as interleaved independent input signals to the second set of power converters.

Using the described power conversion systems, circuits, bus architectures, and methodologies, an intermediate bus architecture in an N+1 application can be implemented without fault protection components such as fuses, isolation diodes, and/or capacitors. In one example, fuses can be eliminated and overload protection can be provided by using the current limit latching function of each intermediate bus power converter. Power losses may be reduced due to the elimination of multiple isolation diodes in series. Efficiency can be increased due to the reduced power losses. Additionally, by eliminating components, a printed circuit board area can be reduced with the described or similar architecture. Furthermore, eliminating components in the intermediate bus architecture may increase reliability and may increase efficiency and lower the cost associated with the components.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modem Legal Usage 624 (2d. Ed. 1995).

1. A system, comprising:
a first set of power converters configured to convert an input power level to one or more output power levels;
a second set of power converters; and
an interleaved intermediate bus configured to supply independent and redundant input to the second set of power converters from the one or more output power levels of the first set of power converters.

2. The system of claim 1, where the first set of power converters include power transformers.

3. The system of claim 1, where the first set of power converters include isolated converters.

4. The system of claim 1, where the second set of power converters include non-isolated converters.

5. The system of claim 1, where interleaved intermediate bus includes outputs from the first set of power converters being operably connected to inputs of the second set of power converters forming multiple independent buses.

6. The system of claim 1, where interleaved intermediate bus is configured without fault protection components.

7. The system of claim 1, where second set of power converters are configured in parallel, and where the second set of power converters configured to receive the redundant input.

8. The system of claim 1, where the system is embedded in a computer system and the second set of power converters are configured to output power to one or more logic devices within the computer system.

9. The system of claim 8, where the second set of power converters have outputs that are selectively combined to generate one or more selected output levels.

10. The system of claim 1, where the system is embedded in one of, computer, an image forming device, a logic device, a printed circuit board, and a circuit.

11. A computer system including a power source for providing power to one or more electronic components within the computer system, comprising:
a power source;
a first group of non-isolated converters configured to have output signals combined to generate a first power output for a first electronic component, the first group of non-isolated converters including a redundant converter;
a second group of non-isolated converters configured to have output signals combined to generate a second power output for a second electronic component, the second group of non-isolated converters including a redundant converter;
a set of isolated converters each configured to convert an input voltage from a power source into an output voltage; and
an intermediate power bus architecture configured to provide the output voltage from one or more isolated converters from the set of isolated converters as an independent input voltage to each non-isolated converter within the first group of non-isolated converters, and an independent input voltage to each non-isolated converter within the second group of non-isolated converters.

12. The computer system of claim 11 where the intermediate power bus architecture includes multiple independent buses configured to provide the output voltage from the set of isolated converters.

13. The computer system of claim 11 where the output voltage from each of the set of isolated converters are selectively operably connected to inputs of the first and second groups of non-isolated converters by an intermediate bus.

14. The computer system of claim 13 where the intermediate power bus architecture being configured to provide a redundant output voltage from the set of isolated converters to the redundant converter from the first and second group of non-isolated converters, respectively.

15. The computer system of claim 13 where the intermediate power bus architecture being configured without fault protection components.

16. The computer system of claim 13 where the set of isolated converters, the first group of non-isolated converters, and the second group of non-isolated converters include one of, AC power transformers, and DC power transformers.

17. A method of converting power, comprising:
providing a input power;
converting the input power to multiple intermediate power levels;
inputting the multiple intermediate power levels as independent input signals to a first set of power converters including a redundant input signal; and
interleaving the multiple intermediate power levels to provide independent input signals to a second set of power converters including a redundant input signal.

18. The method of claim 17, further including outputting one or more power levels from the first and second set of power converters to one or more electronic components.

19. The method of claim 18 where the outputting includes outputting the one or more power levels as one or more different voltage levels.

20. The method of claim 17 where the interleaving provides the independent input signals without including fault protection components.

21. A method of manufacturing a power conversion circuit, comprising:
positioning a plurality of power converters to convert an input voltage to a plurality of intermediate voltages;
grouping at least a first group of power converters to generate a first output voltage including at least one redundant converter, and a second group of power converters to generate a second output voltage including at least one redundant power converter;
operably connecting outputs of the plurality of power converters to inputs of the first group of power converters as independent intermediate buses without including fault protection components; and
operably connecting selected buses of the independent intermediate buses to separate inputs of the second group of power converters without including fault protection components.

22. The method as set forth in claim 21 where the operably connecting includes connecting each of the independent intermediate buses as a one-to-one relationship with each power converter in the first group of power converters, and as a one-to-one relationship with each power converter in the second group of power converters.

23. The method as set forth in claim 22 where the operably connecting forms an interleaved power bus including the independent intermediate buses.

24. A power converting system comprising:
a first power converter means for converting an input power level to an intermediate power level;
a second power converter means for converting the intermediate power level to one or more output power levels; and
a bus means for redundantly connecting the first power converter means to the second power converter means and to supply the intermediate power level as interleaved independent input signals to the second power converter means.

25. The power converting system of claim 24 where first power converter means includes a plurality of power converters being each configured to convert the input power level to the intermediate power level.

26. The power converting system of claim 24 where the bus means being configured without fault protection components.

27. The power converting system of claim 24 where the second power converter means include a plurality of power converters being selectively combined in groups where each group being configured to generate one output power level.

28. The power converting system of claim 27 where:
each group includes at least two power converters from the second power converter means; and
the first power converter means being configured to generate a plurality of intermediate power levels, where each intermediate power level provides input power to no more that one converter per group from the second power converter means.
